(19) United States
(12) Patent Application Publication
(10) Pub. No.: US 2024/0230362 A9
(43) Pub. Date: Jul. 11, 2024

(54) A METHOD AND A SYSTEM FOR WEATHER-BASED HAZARD WARNING GENERATION FOR AUTONOMOUS VEHICLE

(71) Applicant: HERE Global B.V., Eindoven (NL)

(72) Inventors: Amarnath NAYAK, Mumbai (IN); Leon STENNETH, Chicago, IL (US); Alex AVERBUCH, Buffalo Grove, IL (US)

(21) Appl. No.: 17/969,450

(22) Filed: Oct. 19, 2022

(51) Int. Cl. G01C 21/00; G06V 10/764; G06V 10/82; G06V 20/58; G08G 1/01

(52) U.S. Cl. CPC G01C 21/3811; G01C 21/3867; G06V 10/764; G06V 10/82; G06V 20/58; G08G 1/0125; G06V 2201/08

(57) ABSTRACT

The disclosure provides a method, a system, and a computer program product for updating map data. The method comprises obtaining vehicle sensor data associated with first spatial data and first temporal data related to one or more hazard-based event. The method may further include obtaining image data associated with second spatial data and second temporal data related to one or more hazard-based event. The method may further include combining the first spatial data with the second spatial data based on a match between the first spatial data and the second spatial data and between the first temporal data and the second temporal data respectively. The method may further include updating the map data based on the combining.

### TECHNOLOGICAL FIELD

The present disclosure generally relates to navigation and safety engineering for vehicles, particularly relates to systems and methods for updating maps for using in a vehicle.

### BACKGROUND

Various navigation applications are available to aid, for example directions for driving, walking, or other modes of travel. These navigation applications may be web-based and mobile app-based systems that allow a user to request directions from a source to destination. There is a rapid increase in vehicle traffic on the roads and travel times are adversely impacted especially due to weather-based events such as rain, fog, slippery roads and the like. Therefore, the efforts have increased worldwide to identify accurate state of the roads for timely updating of maps and accordingly generating warnings for autonomous vehicles thereby providing better routes in navigation systems.

Therefore, there is a need for improved system and method for providing weather-based hazard warning generation for autonomous vehicle.

### BRIEF SUMMARY

The following presents a simplified summary in order to provide a basic understanding of some novel embodiments described herein. This summary is not an extensive overview, and it is not intended to identify key/critical elements or to delineate the scope thereof. Some concepts are presented in a simplified form as a prelude to the more detailed description that is presented later.

Some example embodiments disclosed herein provide a method for updating map data. The method comprises obtaining vehicle sensor data associated with first spatial data and first temporal data related to one or more hazard-based event. The method may further include obtaining image data associated with second spatial data and second temporal data related to one or more hazard-based event. The method may further include combining the first spatial data with the second spatial data based on a match between the first spatial data and the second spatial data and between the first temporal data and the second temporal data respectively. The method may further include updating the map data based on the combining.

According to some example embodiments, the vehicle sensor data associated with the one or more hazard-based event comprise a first hazard polygon.

According to some example embodiments, the image data associated with the one or more hazard-based event comprise a second hazard polygon.

According to some preferred embodiments, the combining comprises generating a union of the first hazard polygon and the second hazard polygon.

According to some example embodiments, the combining further comprises generating union of first hazard polygon and the second hazard polygon in real time.

According to some preferred embodiments, the one or more hazard events comprise at least of a: rain, fog, slippery road, accident, or broken-down vehicle.

According to some example embodiments, the image data is classified into the hazard-events using Convolutional Neural Network model.

According to some example embodiments, the Convolutional Neural Network model is configured to classify the image data into a day image and a night image.

According to some preferred embodiments, the day image comprises at least of a clear day and rain, clear day and fog, clear day and snow day.

According to some example embodiments, the night image comprises at least of a: clear night and rain, clear night and fog, clear nights, and snow.

Some example embodiments disclosed herein provide a system for updating map data, the system comprising a memory configured to store computer-executable instructions and one or more processors configured to execute the instructions to obtain vehicle sensor data associated with first spatial data and first temporal data related to one or more hazard-based event. The one or more processors are further configured to obtain image data associated with second spatial data and second temporal data related to one or more hazard-based event. The one or more processors are further configured to combine the first spatial data with the second spatial data based on a match between the first spatial data and the second spatial data and between the first temporal data and the second temporal data respectively. The one or more processors are further configured to update the map data based on the combining.

Some example embodiments disclosed herein provide a computer programmable product comprising a non-transitory computer readable medium having stored thereon computer executable instruction which when executed by one or more processors, cause the one or more processors to carry out operations for generating a hazard polygon, the operations comprising obtaining vehicle sensor data associated with first spatial data and first temporal data related to one or more hazard-based event. The operations further comprise obtaining image data associated with second spatial data and second temporal data related to one or more hazard-based event. The operations further comprise combining the first spatial data with the second spatial data based on a match between the first spatial data and the second spatial data and between the first temporal data and the second temporal data respectively. The operations further comprise updating the map data based on the combining.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a block diagram of a network environment of a system for updating map, in accordance with an example embodiment;

FIG. 2A illustrates a block diagram of a system for updating map, in accordance with an example embodiment;

FIG. 2B illustrates an example map database record storing data, in accordance with one or more example embodiments;

FIG. 2C illustrates another example map database record storing data, in accordance with one or more example embodiments;

FIG. 2D illustrates another example map database storing data, in accordance with one or more example embodiments;

FIG. 3 illustrates a block diagram of an architecture for the system and the mapping platform for updating map data, in accordance with an example embodiment;

FIG. 4 illustrates a block diagram of different steps for updating map data, in accordance with an example embodiment;

FIG. 5A illustrates a block diagram of a method performed by a convolutional neural network model classifying traffic image data, in accordance with an example embodiment;

FIG. 5B illustrates a structure of the convolutional neural network model, in accordance with an example embodiment;

FIG. 5C illustrates results of convolutional neural network model, in accordance with an example embodiment;

FIG. 6 illustrates map representing generation of resulting polygon, in accordance with an example embodiment;

FIG. 7 illustrates an example flow chart delineating the operation of system 101 of updating map, in accordance with an example embodiment; and

FIG. 8 illustrates a flow diagram of a method for updating map data, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “route” may be used to refer to a path from a source location to a destination location on any link.

The term “autonomous vehicle” may refer to any vehicle having autonomous driving capabilities at least in some conditions. An autonomous vehicle, as used throughout this disclosure, may refer to a vehicle having autonomous driving capabilities at least in some conditions. The autonomous vehicle may also be known as a driverless car, robot car, self-driving car, or autonomous car. For example, the vehicle may have zero passengers or passengers that do not manually drive the vehicle, but the vehicle drives and maneuvers automatically. There can also be semi-autonomous vehicles.

The term “machine learning model” may be used to refer to a computational or statistical or mathematical model that is based in part or on the whole on artificial intelligence and deep learning techniques. The “machine learning model” is trained over a set of data and using an algorithm that it may use to learn from the dataset.

The term “deep learning” is a type of machine learning that utilizes both structured and unstructured data for training.

The term “convolutional neural network model” may be used to refer to a processing model that is used in image recognition, specifically processing pixel data.

### End of Definitions

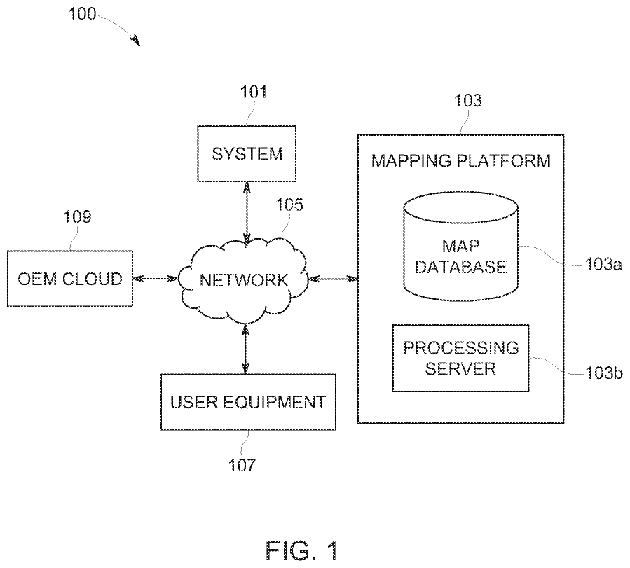

Embodiments of the present disclosure may provide a system, a method, and a computer program product for updating map data. Often times, due to weather-based events such as rain, fog, slippery roads, broken-down vehicles, accidents and the like, the travel time of the user for a destination increases and sometimes the user gets stuck on the road for long hours. Therefore, there is a need for solution for generating warning for autonomous vehicles and providing better route in navigation systems. The system, the method, and the computer program product facilitating updating map data in such an improved manner are described with reference to FIG. 1 to FIG. 8 as detailed below.

FIG. 1 illustrates a block diagram of a network environment 100 of a system 101 for updating map data, in accordance with an example embodiment. The system 101 may be communicatively coupled to a mapping platform 103, a user equipment 107 and an OEM (Original Equipment Manufacturer) cloud 109 via a network 105. The components described in the network environment 100 may be further broken down into more than one component such as one or more sensors or applications in the system 101 and/or combined together in any suitable arrangement. Further, it is possible that one or more components may be rearranged, changed, added, and/or removed.

In an example embodiment, the system 101 may be embodied in one or more of several ways as per the required implementation. For example, the system 101 may be embodied as a cloud-based service or a cloud-based platform. In each of such embodiments, the system 101 may be communicatively coupled to the components shown in FIG. 1 to carry out the desired operations and wherever required modifications may be possible within the scope of the present disclosure. The system 101 may be implemented in a vehicle, where the vehicle may be an autonomous vehicle, a semi-autonomous vehicle, or a manually driven vehicle. Further, in one embodiment, the system 101 may be a standalone unit configured to predicting an accident of a vehicle. Alternatively, the system 101 may be coupled with an external device such as the autonomous vehicle. In an embodiment, the system 101 may also be referred to as the user equipment UE 107. In some example embodiments, the system 101 may be any user accessible device such as a mobile phone, a smartphone, a portable computer, and the like that are portable in themselves or as a part of another portable/mobile object such as a vehicle. The system 101 may comprise a processor, a memory, and a communication interface. The processor, the memory and the communication interface may be communicatively coupled to each other. In some example embodiments, the system 101 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to a user based on a prediction of a vehicle's accident. In such example embodiments, the system 101 may comprise a processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of system 101. Additional, different, or fewer components may be provided. For example, the system 101 may be configured to execute and run mobile applications such as a messaging application, a browser application, a navigation application, and the like. For example, system 101 may be a dedicated vehicle (or a part thereof) for gathering data related to accident of other vehicles in a database map 103a. For example, the system 101 may be a consumer vehicle (or a part thereof). In some example embodiments, the system 101 may serve the dual purpose of a data gatherer and a beneficiary device. The system 101 may be configured to capture sensor data associated with the vehicle or a road which the system 101 may be traversing. The sensor data may for example be audio signals in and outside the vehicle, image data of road objects, road signs, or the surroundings (for example buildings). The sensor data may refer to sensor data collected from a sensor unit in the system 101. In accordance with an embodiment, the sensor data may refer to the data captured by the vehicle using sensors.

In some other embodiments, the system 101 may be an OEM (Original Equipment Manufacturer) cloud, such as the OEM cloud 109. The OEM cloud 109 may be configured to anonymize any data received from the system 101, such as the vehicle, before using the data for further processing, such as before sending the data to the mapping platform 103. In some embodiments, anonymization of data may be done by the mapping platform 103.

The mapping platform 103 may comprise a map database 103a for storing map data and a processing server 103b. The map database 103a may include data associated with vehicle's accidents on road/s, one or more of a road sign, or speed signs, or road objects on the link or path. Further, the map database 103a may store accident data, node data, road segment data, link data, point of interest (POI) data, link identification information, heading value records, or the like. Also, the map database 103a further includes speed limit data of each lane, cartographic data, routing data, and/or maneuvering data. Additionally, the map database 103a may be updated dynamically to cumulate real time traffic conditions based on prediction of vehicle's accident. The real-time traffic conditions may be collected by analyzing the location transmitted to the mapping platform 103 by a large number of road users travelling by vehicles through the respective user devices of the road users. In one example, by calculating the speed of the road users along a length of road, the mapping platform 103 may generate a live traffic map, which is stored in the map database 103a in the form of real time traffic conditions based on prediction of vehicle's accident. In one embodiment, the map database 103a may further store historical traffic data that includes travel times, accident prone areas, areas with least and maximum accidents, average speeds and probe counts on each road or area at any given time of the day and any day of the year. According to some example embodiments, the road segment data records may be links or segments representing roads, streets, or paths, as may be used in calculating a route or recorded route information for determination of one or more personalized routes to avoid a zone/route with the predicted accident. The node data may be end points corresponding to the respective links or segments of road segment data. The road link data and the node data may represent a road network used by vehicles such as cars, trucks, buses, motorcycles, and/or other entities. Optionally, the map database 103a may contain path segment and node data records, such as shape points or other data that may represent pedestrian paths, links, or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 103a may also store data about the POIs and their respective locations in the POI records. The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a may include event data (e.g., traffic incidents, construction activities, scheduled events, unscheduled events, vehicle accidents, diversions etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data.

In some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services in an event of a predicted vehicle's accident, such as route calculation, route guidance, map display, speed calculation, distance and travel time functions, and other functions, by a navigation device, such as by the system 101 or by the user equipment 107. The navigation-related functions may correspond to vehicle navigation, pedestrian navigation, or other types of navigation to avoid a zone where the vehicle accident has been predicted by the system 101. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in the system 101 to provide navigation and/or map-related functions in an event of a predicted vehicle's accident. For example, the map database 103a may be used with the system 101 to provide an end user with navigation features. In such a case, the map database 103a may be downloaded or stored locally (cached) on the system 101.

The processing server 103b may comprise processing means, and communication means. For example, the processing means may comprise one or more processors configured to process requests received from the system 101. The processing means may fetch map data from the map database 103a and transmit the same to the system 101 via the OEM cloud 109 in a format suitable for use by the system 101. In one or more example embodiments, the mapping platform 103 may periodically communicate with the system 101 via the processing server 103b to update a local cache of the map data stored on the system 101. Accordingly, in some example embodiments, the map data may also be stored on the system 101 and may be updated based on periodic communication with the mapping platform 103. In some embodiments, the map data may also be stored on the user equipment 107 and may be updated based on periodic communication with the mapping platform 103.

In some example embodiments, the user equipment 107 may be any user accessible device such as a mobile phone, a smartphone, a portable computer, and the like, as a part of another portable/mobile object such as a vehicle. The user equipment 107 may comprise a processor, a memory, and a communication interface. The processor, the memory and the communication interface may be communicatively coupled to each other. In some example embodiments, the user equipment 107 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example embodiments, the user equipment 107 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 107. Additional, different, or fewer components may be provided. In one embodiment, the user equipment 107 may be directly coupled to the system 101 via the network 105. For example, the user equipment 107 may be a dedicated vehicle (or a part thereof) for gathering data for development of the map data in the database 103a. In some example embodiments, at least one user equipment such as the user equipment 107 may be coupled to the system 101 via the OEM cloud 109 and the network 105. For example, the user equipment 107 may be a consumer vehicle (or a part thereof) and may be a beneficiary of the services provided by the system 101. In some example embodiments, the user equipment 107 may serve the dual purpose of a data gatherer and a beneficiary device. The user equipment 107 may be configured to capture sensor data associated with a road which the user equipment 107 may be traversing. The sensor data may for example be image data of road objects, road signs, or the surroundings. The sensor data may refer to sensor data collected from a sensor unit in the user equipment 107. In accordance with an embodiment, the sensor data may refer to the data captured by the vehicle using sensors. The user equipment 107, may be communicatively coupled to the system 101, the mapping platform 103 and the OEM cloud 109 over the network 105.

The network 105 may be wired, wireless, or any combination of wired and wireless communication networks, such as cellular, Wi-Fi, internet, local area networks, or the like. In one embodiment, the network 105 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an example, the mapping platform 103 may be integrated into a single platform to provide a suite of mapping and navigation related applications for OEM devices, such as the user devices and the system 101. The system 101 may be configured to communicate with the mapping platform 103 over the network 105. Thus, the mapping platform 103 may enable provision of cloud-based services for the system 101, such as, storing the lane marking observations in an OEM cloud in batches or in real-time.

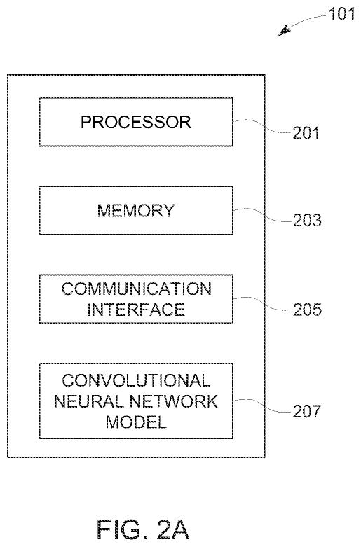

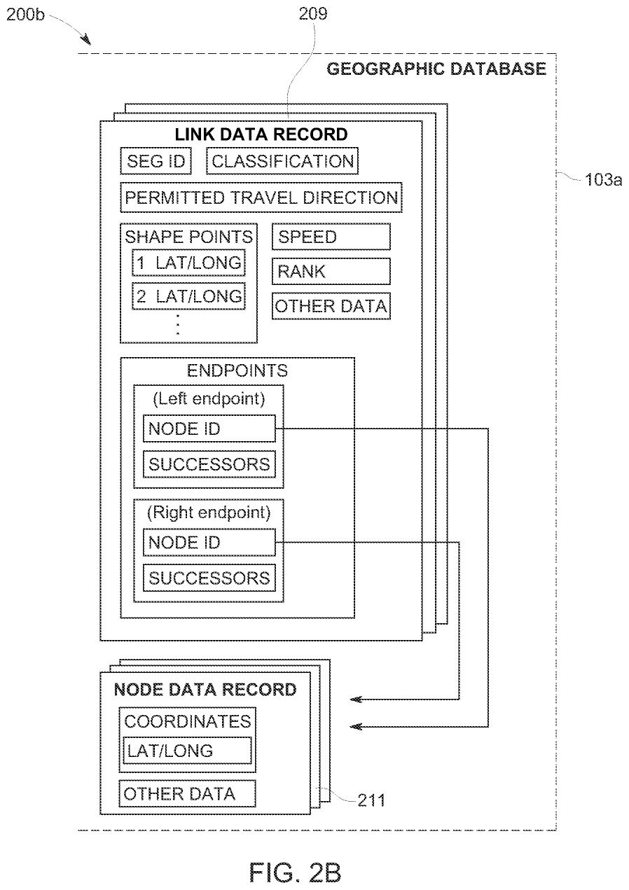

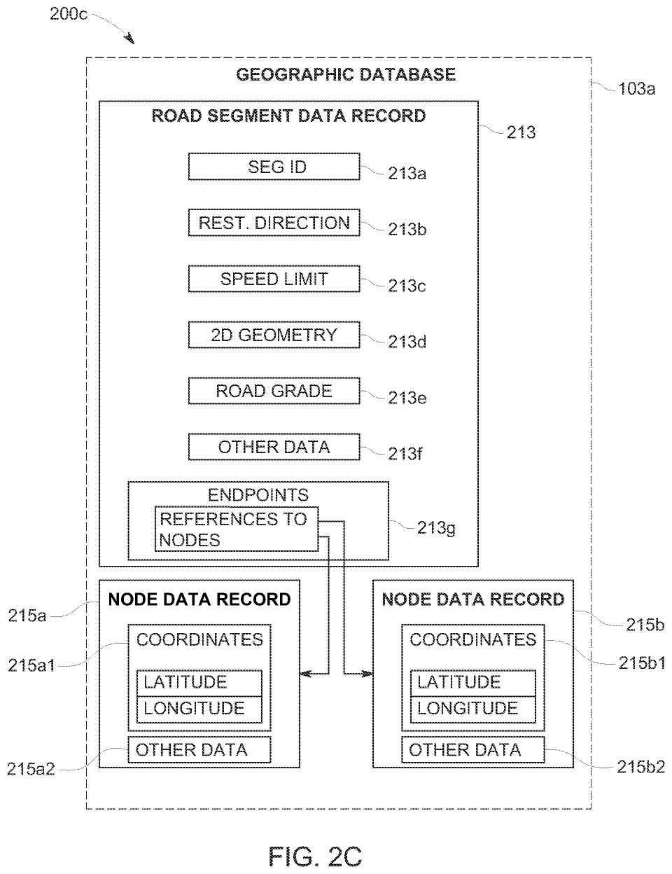

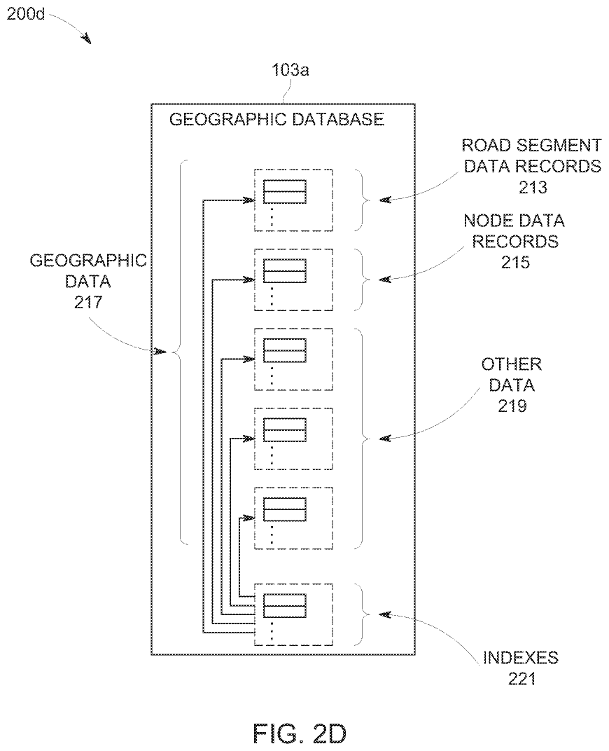

FIG. 2A illustrates a block diagram of the system 101 for providing navigational assistance, in accordance with an example embodiment. The system 101 may include a processing means such as at least one processor 201 (hereinafter, also referred to as “processor 201”), storage means such as at least one memory 203 (hereinafter, also referred to as “memory 203”), and a communication means such as at least one communication interface 205 (hereinafter, also referred to as “communication interface 205”) and a convolutional neural network model 207. The processor 201 may retrieve computer program code instructions that may be stored in the memory 203 for execution of the computer program code instructions.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

In some embodiments, the processor 201 may be configured to provide Internet-of-Things (IoT) related capabilities to users of the system 101, where the users may be a traveler, a rider, a pedestrian, and the like. In some embodiments, the users may be or correspond to an autonomous or a semi-autonomous vehicle. The IoT related capabilities may in turn be used to provide smart navigation solutions by providing real time updates to the users to take pro-active decision on turn-maneuvers, lane changes, overtaking, merging and the like, big data analysis, and sensor-based data collection by using the cloud-based mapping system for providing navigation recommendation services to the users. The system 101 may be accessed using the communication interface 205. The communication interface 205 may provide an interface for accessing various features and data stored in the system 101.

Additionally, or alternatively, the processor 201 may include one or more processors capable of processing large volumes of workloads and operations to provide support for big data analysis. In an example embodiment, the processor 201 may be in communication with the memory 203 via a bus for passing information among components coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communications to and from the system 101 or any other component with which the system 101 may communicate. The communication interface 205 may be any means such as a device or circuitry embodied in either hardware or a combination of hardware and software that is configured to receive and/or transmit data to/from a communications device in communication with the system 101. In this regard, the communication interface 205 may include, for example, an antenna (or multiple antennae) and supporting hardware and/or software for enabling communications with a wireless communication network. Additionally, or alternatively, the communication interface 205 may include the circuitry for interacting with the antenna(s) to cause transmission of signals via the antenna(s) or to handle receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms. In some embodiments, the communication interface 205 may enable communication with a cloud-based network to enable deep learning, such as using the convolutional neural network model 207.

The convolutional neural network model 207 may refer to recognition and processing of images, specifically pixel data. The convolutional neural network model 207 may include Deep Neural Network (DNN) that includes deep learning of the data using a machine learning algorithm. The purpose of DNN is to predict the result which otherwise are given by human brain. For this purpose, the DNN is trained on large sets of data. In an example embodiment, the system 101 may also use a convolutional neural network model for training the dataset for the DNN. For example, the convolutional neural network model 207 may be a federated learning model. In an embodiment, federated learning basically allows training deep neural networks on a user's private data without exposing it to the rest of the world. Additionally, federated learning may allow for deep neural networks to be deployed on a user system, such as the system 101, and to learn using their data locally.

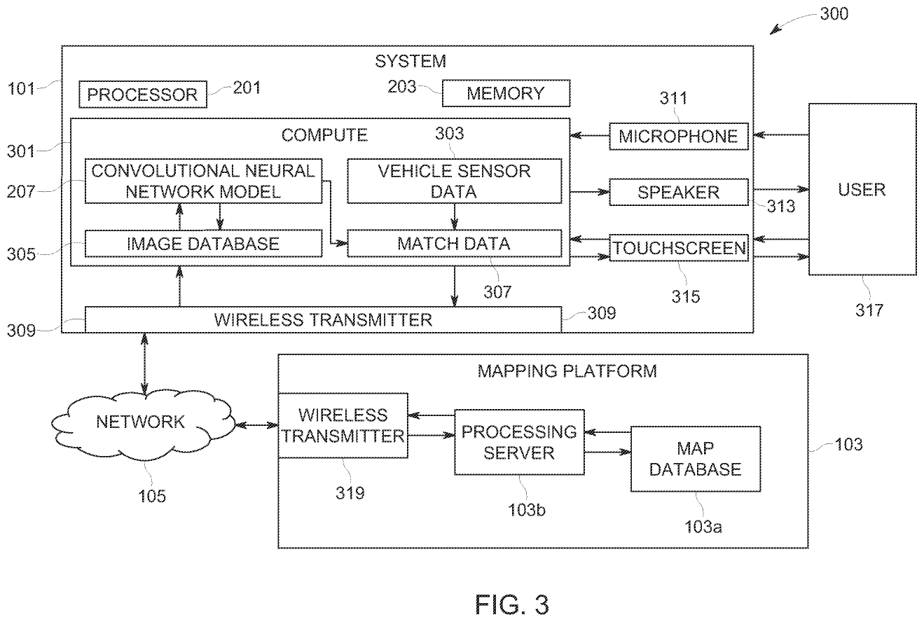

In some embodiments, the convolutional neural network model 207 is embodied within the processor 201, and the representation shown in FIG. 2A is for exemplar purpose only. The convolutional neural network model 207 may provide the necessary intelligence needed by the system 101 for updating map data, using the architecture shown in FIG. 3.

FIG. 2B shows format of the map data 200b stored in the map database 103a according to one or more example embodiments. FIG. 2B shows a link data record 209 that may be used to store data about one or more of the feature lines. This link data record 209 has information (such as “attributes”, “fields”, etc.) associated with it that allows identification of the nodes associated with the link and/or the geographic positions (e.g., the latitude and longitude coordinates and/or altitude or elevation) of the two nodes. In addition, the link data record 209 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents another-than-straight road segment may include shape point data. A shape point is a location along a link between its endpoints. To represent the shape of other-than-straight roads, the mapping platform 103 and its associated map database developer selects one or more shape points along the other-than-straight road portion. Shape point data included in the link data record 209 indicate the position, (e.g., latitude, longitude, and optionally, altitude or elevation) of the selected shape points along the represented link.

Additionally, in the compiled geographic database, such as a copy of the map database 103a, there may also be a node data record 211 for each node. The node data record 211 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 2C shows another format of the map data 200c stored in the map database 103a according to one or more example embodiments. In the FIG. 2C, the map data 200c is stored by specifying a road segment data record 213. The road segment data record 213 is configured to represent data that represents a road network. In FIG. 2C, the map database 103a contains at least one road segment data record 213 (also referred to as “entity” or “entry”) for each road segment in a geographic region.

The map database 103a that represents the geographic region of FIG. 2A also includes a database record 215 (a node data record 215a and a node data record 215b) (or “entity” or “entry”) for each node associated with the at least one road segment shown by the road segment data record 213. (The terms “nodes” and “segments” represent only one terminology for describing these physical geographic features and other terminology for describing these features is intended to be encompassed within the scope of these concepts). Each of the node data records 215a and 215b may have associated information (such as “attributes”, “fields”, etc.) that allows identification of the road segment(s) that connect to it and/or its geographic position (e.g., its latitude and longitude coordinates).

FIG. 2C also shows some of the components of the road segment data record 213 contained in the map database 103a. The road segment data record 213 includes a segment ID 213a by which the data record can be identified in the map database 103a. Each road segment data record 213 has associated with it information (such as “attributes”, “fields”, etc.) that describes features of the represented road segment. The road segment data record 213 may include data 213b that indicate the restrictions, if any, on the direction of vehicular travel permitted on the represented road segment. The road segment data record 213 includes data 213c that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 213 may also include data 213d indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 213 also includes road grade data 213e that indicate the grade or slope of the road segment. In one embodiment, the road grade data 213e include road grade change points and a corresponding percentage of grade change. Additionally, the road grade data 213e may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 213e includes the road grade change points and an actual road grade value for the portion of the road segment after the road grade change point until the next road grade change point or end node. In a further embodiment, the road grade data 213e includes elevation data at the road grade change points and nodes. In an alternative embodiment, the road grade data 213e is an elevation model which may be used to determine the slope of the road segment.

The road segment data record 213 also includes data 213g providing the geographic coordinates (e.g., the latitude and longitude) of the end points of the represented road segment. In one embodiment, the data 213g are references to the node data records 213 that represent the nodes corresponding to the end points of the represented road segment.

The road segment data record 213 may also include or be associated with other data 213f that refer to various other attributes of the represented road segment. The various attributes associated with a road segment may be included in a single road segment record or may be included in more than one type of record which cross-reference each other. For example, the road segment data record 213 may include data identifying the name or names by which the represented road segment is known, the street address ranges along the represented road segment, and so on.

FIG. 2C also shows some of the components of the node data record 215 contained in the map database 103a. Each of the node data records 215 may have associated information (such as “attributes”, “fields”, etc.) that allows identification of the road segment(s) that connect to it and/or it's geographic position (e.g., its latitude and longitude coordinates). For the embodiment shown in FIG. 2C, the node data records 215a and 215b include the latitude and longitude coordinates 215a1 and 215b1 for their nodes. The node data records 215a and 215b may also include other data 215a2 and 215b2 that refer to various other attributes of the nodes.

Thus, the overall data stored in the map database 103a may be organized in the form of different layers for greater detail, clarity, and precision. Specifically, in the case of high-definition maps, the map data may be organized, stored, sorted, and accessed in the form of three or more layers. These layers may include road level layer, lane level layer and localization layer. The data stored in the map database 103a in the formats shown in FIGS. 2B and 2C may be combined in a suitable manner to provide these three or more layers of information. In some embodiments, there may be lesser or fewer number of layers of data also possible, without deviating from the scope of the present disclosure.

FIG. 2D illustrates a block diagram 200d of the map database 103a storing map data or geographic data 217 in the form of road segments/links, nodes, and one or more associated attributes as discussed above. Furthermore, attributes may refer to features or data layers associated with the link-node database, such as an HD lane data layer.

In addition, the map data 217 may also include other kinds of data 219. The other kinds of data 219 may represent other kinds of geographic features or anything else. The other kinds of data may include point of interest data. For example, the point of interest data may include point of interest records comprising a type (e.g., the type of point of interest, such as restaurant, ATM, etc.), location of the point of interest, a phone number, hours of operation, etc. The map database 103a also includes indexes 221. The indexes 221 may include various types of indexes that relate the different types of data to each other or that relate to other aspects of the data contained in the geographic database 103a.

The data stored in the map database 103a in the various formats discussed above may help in provide precise data for high-definition mapping applications, autonomous vehicle navigation and guidance, cruise control using ADAS, direction control using accurate vehicle maneuvering and other such services. In some embodiments, the system 101 accesses the map database 103a storing data in the form of various layers and formats depicted in FIGS. 2B-2D.

FIG. 3 illustrates a block diagram 300 of the system 101 and the mapping platform 103 for updating map data, in accordance with an example embodiment. The block diagram 300 may include an in-vehicle device which is similar to the system 101 in communication with a user 317. The system 101 (or also interchangeably the in-vehicle device) may include a processor 201, a memory 203, a compute component 301, a convolutional neural network model 207, a vehicle sensor data 303, an image database 305, a match data 307, a wireless transmitter 309, a microphone 311, a speaker 313 and a touch screen 315. Further, the system 101 is in communication with the mapping platform 103 via network 105. The mapping platform 103 may include a wireless transmitter 319, a processing server 103b, and a map database 103a.

In various embodiments, the system 101 may be the in-vehicle device. In some embodiments, the user 317 may be a traveler, a rider, a pedestrian, and the like. In some embodiments, the user 317 may be or correspond to an autonomous or a semi-autonomous vehicle. The components such as the microphone 311, the speaker 313 and the touch screen 315 may be used as the interface 205. The microphone 311 may receive voice command or speech input by the user 317. In an embodiment, the user 317 may also give instructions on the touch screen 315. In an embodiment, the user 317 may want to know the route or navigational information and for this purpose the user 317 may either give voice command or set destination location in an application using the touch screen 315. The system 101 may give output data to the user 317 by using speaker 313 In an example embodiment, the output data may comprise warning instructions, navigational instructions.

In an embodiment, the system 101 may aid the user while travelling on a route provided by the navigation system in a vehicle. The system 101 may generate warning, navigational instructions by providing alternate safe route and updating map data, on detecting hazard-based events on the route.

In some embodiments, the compute component 301 of the system 101 may be configured to perform different operations, algorithms, and functions. To that end, the compute component 301 may be same as the system 101 shown in FIG. 2A.

In an embodiment, the system 101 may provide digital assistance using cloud computing. In an embodiment, the compute component 303 may also include the image database 305 that may obtain traffic image data. The traffic image data may be obtained in real time from the traffic cameras installed in an area. In an embodiment, the image database 305 may obtain traffic image data via a cloud-based server or a remote server. In an embodiment, the compute component 303 may also include the convolutional neural network model 207. The convolutional neural network model 207 may receive traffic image data from the image database 305. Thereafter, the convolutional neural network model 207 may classify the traffic image data and extract spatial and temporal data of the area on detecting hazard-based event on the ongoing route. For example, the hazard-based event may include rain, fog, slippery road, accident, or broken-down vehicle.

In an embodiment, the convolutional neural network model 207 may be configured for providing deep learning capabilities for updating map database and providing navigational assistance.

In an embodiment, the compute component 301 may also include vehicle sensor data 303 that may be obtained from the sensors in the vehicle on detecting hazard-based events. In some preferred embodiments the sensor data may be obtained before the detection of hazard-based events. Thereafter, vehicle sensor data 303 may include spatial and temporal data as well.

In an embodiment, the compute component 303 may also further include the match component 307. The spatial and temporal data from the convolution neural network model 207 and vehicle sensor data 305 are processed in the match component 307. If the spatial data from both the convolution neural network model 207 and vehicle sensor data 302 as well as temporal data from the convolution neural network model 207 and vehicle sensor data 302 matches, then the spatial data from the convolution neural network model 207 is combined with the spatial data from vehicle sensor data 303 in the match data 307.

In an embodiment, the compute component 301 is embodied as an executor of software instructions, the instructions may specifically configure the compute component 301 to perform the algorithms and/or operations described herein when the instructions are executed.

In an embodiment, the system 101 may transmit the stored data from wireless transmitter 309 to wireless transmitter 319 of the mapping platform 103. In an embodiment, the mapping platform 103 may be implemented as a cloud-based server or a remote server. In the present invention, the mapping platform 103 is implemented as a cloud-based server. The mapping platform 103 may also perform all the computing functions or operations using the processing server 103b. Further, processing server 103b may include a sub-set of instructions configured to aid the system 101. These instructions may include such as instructions for enabling provision of route guidance information, time of arrival information for user destination and the like. In an embodiment, the processing server 103b provides traffic images to the user 317. In an embodiment, the input data may be stored in the mapping platform 103 after using the input data as a training dataset for the DNN discussed earlier. The system 101 may retrieve the stored data from the system 101 or the mapping platform 103, use it to train the DNN, and further use the trained DNN to provide the output data for the user, which is used to provide required digital assistant, that is the system 101. That is to say, on detecting the weather-based hazard such as rain and fog, the system 101 updates the map database 103a based on processing the vehicle sensor data 303 and traffic images. The system 101 also informs the user 317 of the traffic or road conditions by generating warning and providing alternate navigational routes. Thus, the system 101 may provide digital assistance, such as navigational assistance, by edge computing or cloud computing technology or both, as may be desirable according to user conditions, preferences, and limitations.

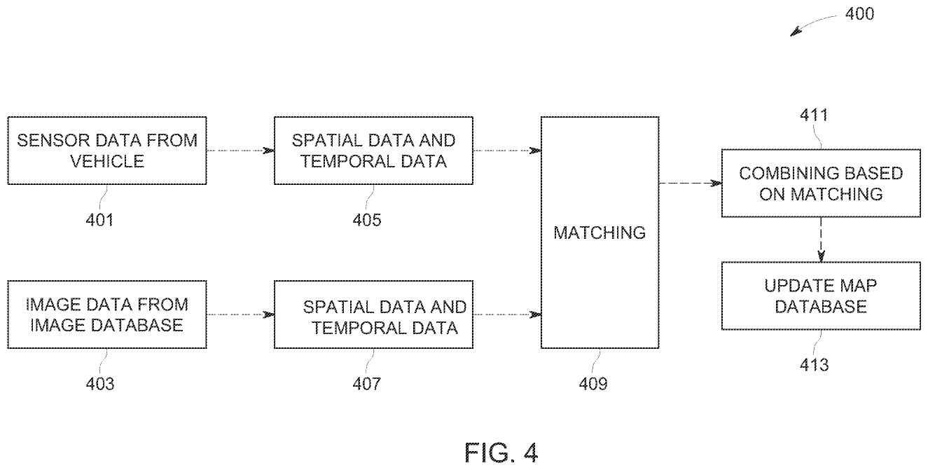

FIG. 4 illustrates a block diagram 400 of different steps for updating map data, in accordance with an example embodiment. Starting at block 401, the system 101 (hereinafter, the system 101 may also be referred to as the vehicle) may be configured to obtain sensor data 303 from vehicle. In an embodiment, the sensor in the vehicle (hereinafter, the sensor in the vehicle may also be referred to as the vehicle sensor) maybe, but not limited to temperature sensor, proximity sensor, accelerometer, IR sensor (infrared sensor), pressure sensor, light sensor, ultrasonic sensor, smoke and gas sensor, touch sensor, colour sensor, humidity sensor, position sensor, magnetic sensor (hall effect sensor), microphone (sound sensor), tilt sensor, flow and level sensor, PIR (passive infrared) sensor, touch sensor, strain and weight sensor. For example, the data from windshield wiper and low beam lights may be used to detect hazard-based events.

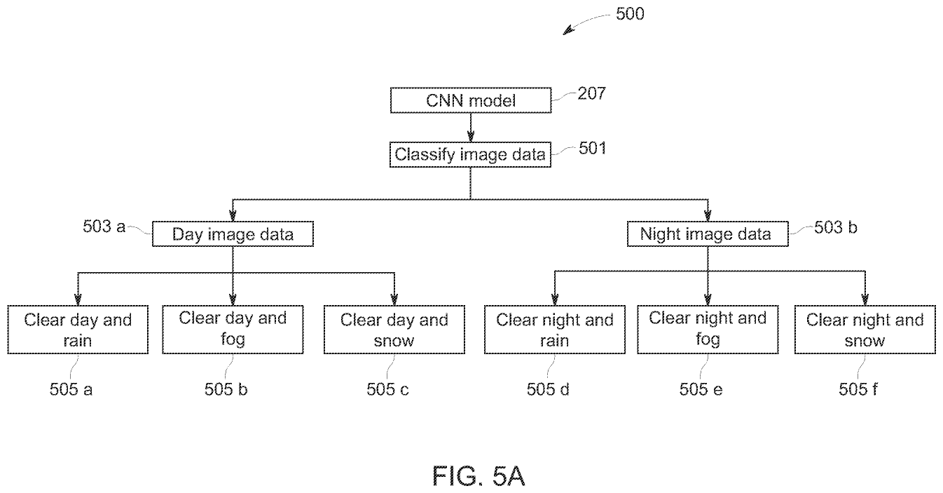

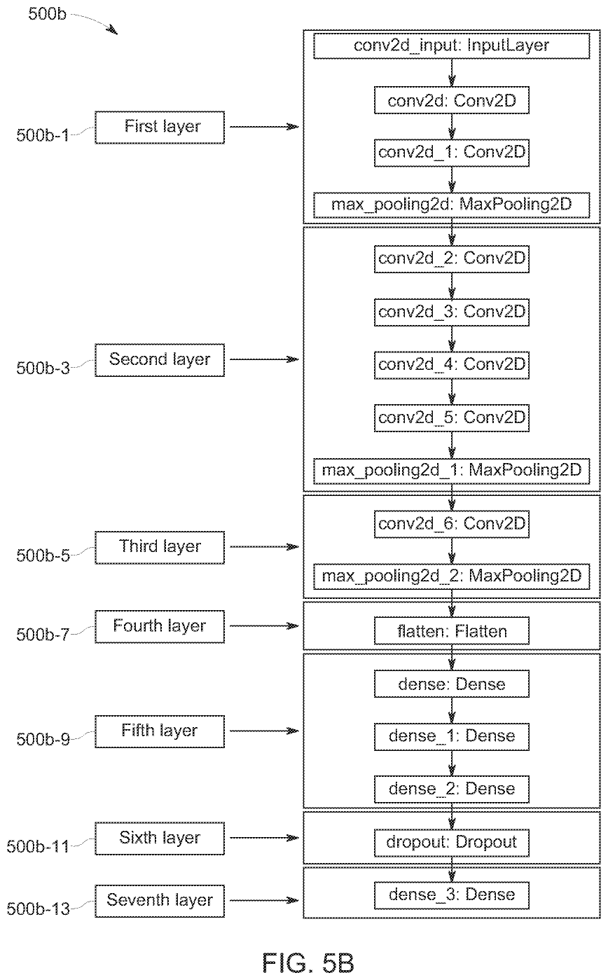

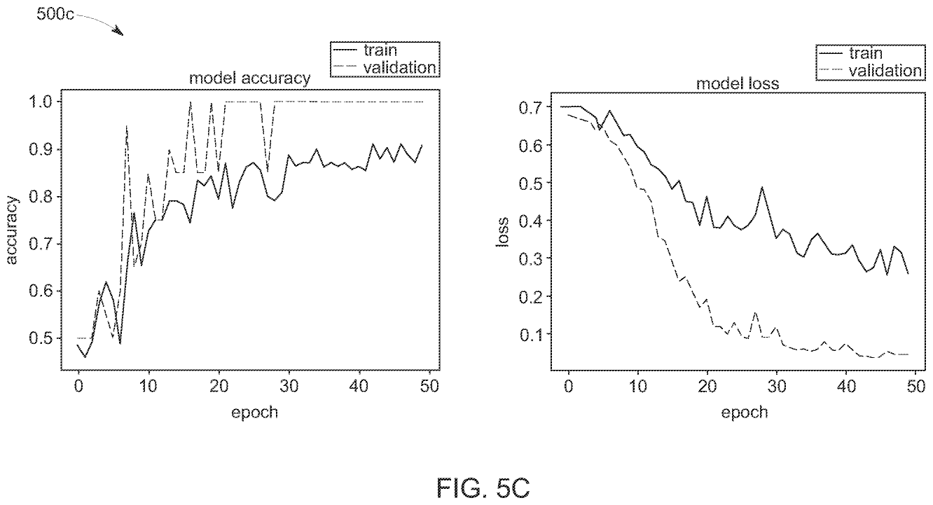

At block 403, the system 101 may be configured to obtain image data from image database 305. The image database 305 is updated from images captured by traffic cameras. Further, the traffic cameras may be either static or hotspot located at various roads and highways. In an embodiment, the image database 305 that may obtain traffic image data. Further, the traffic image data may be obtained in real time from the traffic cameras installed in an area. The system 101 may classify the traffic image data 305 using convolutional neural network (CNN) model to 207 determine a hazard-based event. The hazard-events comprise at least one of a: rain, fog, slippery road, accident, or broken-down vehicle. The traffic image data, as explained in FIG. 5A, may be classified by the CNN model 207 into a day image data and a night image data. The day image data is further classified into a clear day and rain, a clear day and fog, a clear day and snow day. The night image data is also classified into a clear night and rain, a clear night and fog, a clear nights and snow.

At block 405, the system 101 may extract spatial data and temporal data of the area from vehicle sensor data. Thereafter, the spatial data and temporal data associated with vehicle sensor data is exacted for further processing. The spatial data, for example, may be a number of attributes about a location such as map coordinates represented by latitude and longitude. The temporal data, for example, may be date, time stamp and time-interval information.

At block 407, on determining hazard-based event from traffic image data, the system 101 may extract spatial data and temporal data of the area from the traffic image. The spatial data denotes the traffic camera's location in terms of map coordinates represented by latitude and longitude. The temporal data is the date, time stamp and time interval of the traffic image data.

In the above example, when the hazard-based event is detected by the vehicle sensor in the area, in parallel, the system 101 obtains traffic image data of the area which is then classified by CNN model as explained in FIG. 5A. On determining hazard-based event as obtained by classification of the traffic image data by the CNN model, the spatial data and the temporal data associated with traffic image data is extracted for further processing.

At block 405, the system 101 may match the spatial data associated with vehicle data 303 with the spatial data associated with traffic image data and the temporal data associated with vehicle data with the temporal data associated with traffic image data.

At block 411, if the spatial data and temporal data at block 405 matches, then the system 101 may combine the spatial data associated with vehicle sensor data with the spatial data associated with traffic image data.

At block 413, the system 101 may update the map database 103a based on the combined spatial data from vehicle sensor data as well as traffic image data. Therefore, the widest possible area is encapsulated under the hazard-based event detected area and accordingly, the map data is updated. In the above example, on processing the spatial data and temporal data associated with vehicle sensor as well as traffic image as mentioned at block 405 and 407, a wide area is detected for hazard-based event. Accordingly, the map is updated and user travelling on the route is warned and an alternate route is provided by the navigation system. The map updating allows other users travelling on the route at the time to be warned of the hazard-based event and accordingly an alternate route is provided by the navigation system thereby saving travel time and providing better user experience.

FIG. 5A illustrates a block diagram 500 of processing performed by a convolutional neural network (CNN) model 207 for classifying traffic image data, in accordance with an example embodiment. The block diagram 500 may include a CNN model 207 that receives traffic image data. The traffic image data may be obtained in real time from the traffic cameras installed in an area via a cloud-based server or a remote server. Thereafter, the CNN model 207 classifies the traffic image data 501 (such as from image database 305) into a day image data 503a and a night image data 503b. The day image data 503a is further classified into a clear day and rain 505a, a clear day and fog 505b, a clear day and snow day 505c. The night image data 503b is also classified into a clear night and rain 505d, a clear night and fog 505e, a clear nights and snow 505f. Further, the output of this pipelined structure of CNN model 207 is not mutually exclusive. In addition, there is a high chance that model may predict the image as day rain and day fog and therefore, in such case, the probability of prediction may be used to arrive at a conclusion.

FIG. 5B illustrates a structure 500b of the convolutional neural network model 207, in accordance with an example embodiment. The CNN model 207 may classify the weather images from the input traffic image data. The CNN model 207 receives traffic image data, uses the image's raw pixel data, trains the model, then extracts the features for classification into day image data and night image data. The CNN model 207 may include seven different layers: a first layer, 500b-1, a second layer 500b-3, a third layer 500b-5, a fourth layer 500b-7 for converting matrix to single array, a fifth layer 500b-9 which is a deeply connected neural network layer, a sixth layer 500b-11 which switches off weak neuron and the seventh layer 500b-13 which is the output layer. At the output layer, the traffic image data is classified. The number of layers shown as seven on the FIG. 5B is for example purpose only, and fewer or more layers may equivalently be used, without deviating from the scope of the present disclosure.

Example Embodiment of CNN Model 207:
model=Sequential( )
#Conv2D: Two dimenstional convulational model.
#32: Input for next layer
#(3,3) convulonational windows size
model.add(Conv2D(32, (3, 3), input shape=input shape))
model.add(Activation(‘relu’))
model.add(MaxPooling2D(pool size=(2, 2)))
model.add(Conv2D(32, (3, 3)))
model.add(Activation(‘relu’))
model.add(MaxPooling2D(pool size=(2, 2)))
model.add(Conv2D(64, (3, 3)))
model.add(Activation(‘relu’))
model.add(MaxPooling2D(pool size=(2, 2)))
model.add(Flatten( )) #Output convert into one dimension layer and will go to Dense layer
model.add(Dense(64))
model.add(Activation(‘relu’))
model.add(Dropout(0.5))
model.add(Dense(3))
model.add(Activation(‘softmax’))
model.compile(optimizer=Optimizer.Adam(lr=0.0001),loss=′sparse categorical crossentropy′,metrics=[‘accuracy’])

In an example embodiment, the CNN model 207 of FIG. 5A is trained using the traffic image data to classify into two classes: clear day and rain. Example Table 1 below depicts the training of data sets using CNN model 207 to classify images.

EXAMPLE TABLE 1

| | Clear day | Wet day |
|---|---|---|
| Train data set | 72 | 72 |
| Validation data set | 10 | 10 |
| Test data set | 18 | 18 |

FIG. 5C illustrates results of performance of the CNN model 207, in accordance with an example embodiment. The CNN model 207 accuracy and model loss is shown in FIG. 5C for the above Example Table 1.

Example table 2 below depicts a confusion matrix for the output of CNN model 207 on classification of traffic image as disused in the above example table 1. The confusion matrix is a table that is used to describe the performance of a classification model (or “classifier”) on a set of test data for which the true values are known. The confusion matrix below provides a summary of prediction results on traffic image data classification. The number of correct and incorrect predictions of weather data of 18 sample images for clear day and wet day classification are summarized with count values.

EXAMPLE TABLE 2

| | Clear day | Wet day |
|---|---|---|
| True clear day (18) | 18 | 0 |
| True wet day (18) | 11 | 7 |

In the example table above, the CNN model shows accuracy: 69%, precision: 81% and recall: 69%. This binary model classifies the images with 81% precision. The CNN model may be able to classify the images with a reasonable precision.

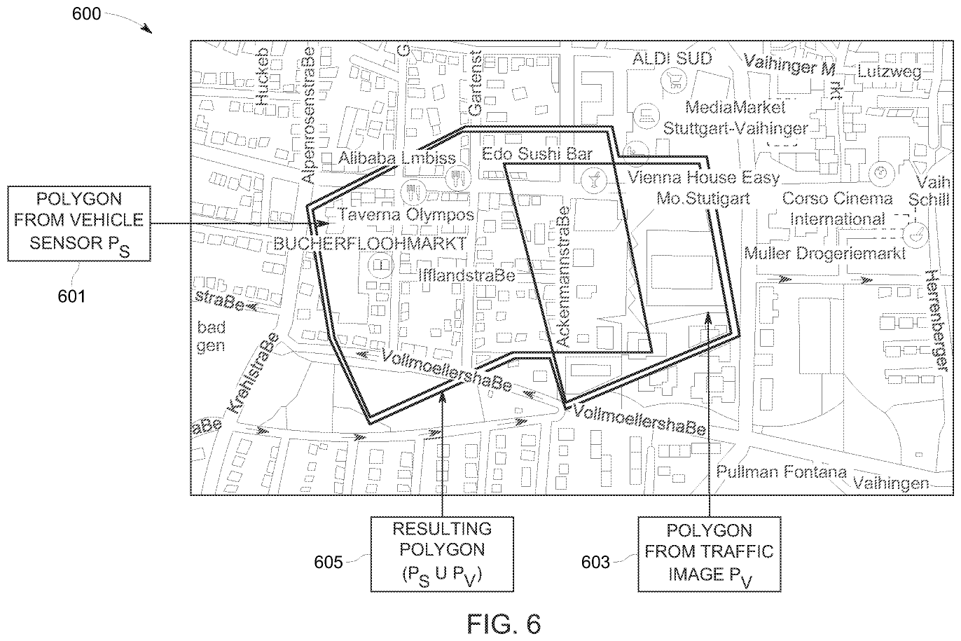

FIG. 6 illustrates a map 600 representing generation of resulting polygon, in accordance with an example embodiment. The polygon is digitally transposed on the map based on spatial data and temporal data from the vehicle sensor data 303 and image data 305. The polygon denotes a spatial area on the map linked to a hazard in a temporal window. The map 600 may include a polygon P s 601 (first hazard polygon) from the vehicle sensor data 303 associated with the spatial data (first spatial data) and the temporal data (first temporal data) related to the one or more hazard-based event. The map 600 may include a polygon P, 603 (second hazard polygon) from the image data 305 (image database 305 is interchangeably referred as image data 305) associated with the spatial data (second spatial data) and temporal data (second temporal data) related to the one or more hazard-based event. The map 600 generates a resulting polygon 605 generated by a union of the polygon Pₛ and polygon Pᵥ, i.e., (P_{S} U P_{V}). In other alternate embodiments the resultant polygon maybe the intersection of the two polygons. Further, the resulting polygon may be generated in real time.

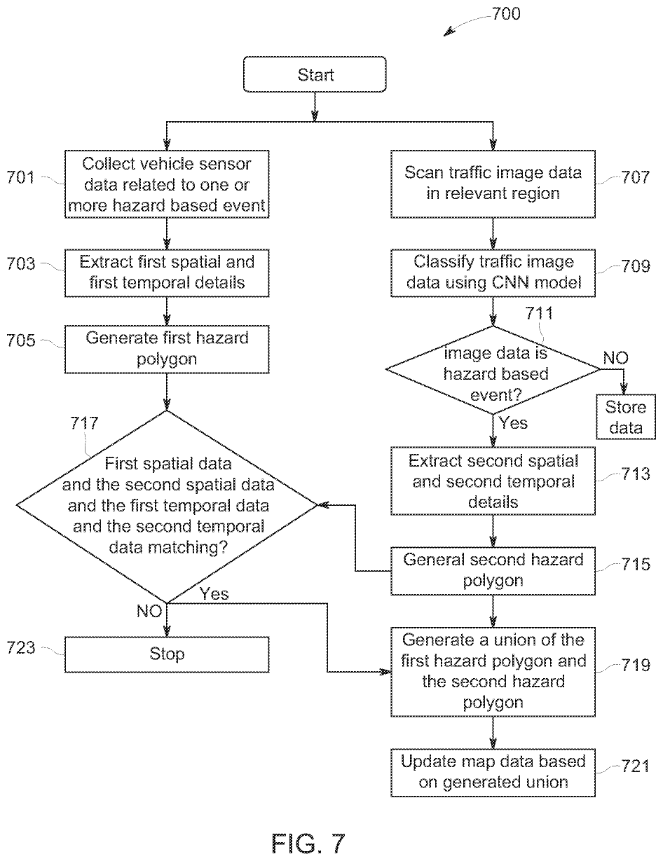

FIG. 7 illustrates an example flow chart of a method 700 of the operation of system 101 for updating map data, in accordance with an example embodiment. It will be understood that each block of the flow diagram of the method 800 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

At step 701, the system 101 collects vehicle sensor data 303 related to one or more hazard-based events. The one or more hazard events comprise at least one of a: rain, fog, slippery road, accident, or broken-down vehicle. The vehicle sensor data maybe, but not limited to temperature sensor, proximity sensor, accelerometer, IR sensor (infrared sensor), pressure sensor, light sensor, ultrasonic sensor, smoke and gas sensor, touch sensor, colour sensor, humidity sensor, position sensor, magnetic sensor (hall effect sensor), microphone (sound sensor), tilt sensor, flow and level sensor, PIR (passive infrared) sensor, touch sensor, strain, and weight sensor. For example, the data from windshield wiper and low beam lights may be used to detect hazard-based events. At step 703, the system 101 extracts first spatial and first temporal details from the vehicle sensor data 303 related to one or more hazard-based events.

At step 705, a first hazard polygon 601 is generated by the system 101 based on extracted first spatial and first temporal details from the vehicle sensor data 303 related to one or more hazard-based events.

On detecting hazard-based event, the system 101 in parallel scans traffic image data 303 the relevant region, at step 707

At step 709, the traffic image data 305 is classified using CNN model 207 by the system 101. The CNN model 207 classifies the image data 305 into a day image 505a and a night image 505b. Further, the day image 505a comprises at least of a: clear day and rain 507a, clear day and fog 507b, clear day and snow day 507c. The night image 505b comprises at least of a: clear night and rain 507d, clear night and fog 507e, clear nights, and snow 507f.

At step 711, the system 101 determines if image data 305 is related to hazard-based event. If yes, then at step 713, the system 101 extracts second spatial data and second temporal data related details. If no, then the system 101 stores data in database to be used for recall purposes. At step 715, the system 101 generates a second hazard polygon 603. At step 717, the system 101 matches first spatial data and the second spatial data and the first temporal data and the second temporal data. If the data are matched, then a union 605 of the first hazard polygon 601 and the second hazard polygon 603 is generated by the system 101 at step 719. Further, at step 721, the map data is updated based on generated union 605. If no, then the system 101 stops and no further action is performed at step 721.

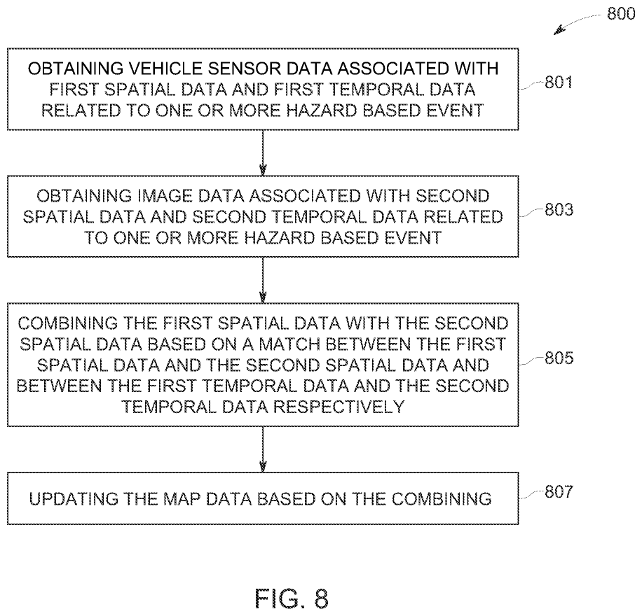

FIG. 8 illustrates a flow diagram of another method 800 for providing updating map data, in accordance with an example embodiment. It will be understood that each block of the flow diagram of the method 800 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 202 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 800 illustrated by the flowchart diagram of FIG. 8 is used for updating map data. Fewer, more, or different steps may be provided.

At step 801, the method 800 comprises obtaining vehicle sensor data associated with first spatial data and first temporal data related to one or more hazard-based event. The one or more hazard events comprise at least of a: rain, fog, slippery road, accident, or broken-down vehicle. The vehicle sensor data associated with the one or more hazard-based event comprise a first hazard polygon.

At step 803, the method 800 comprises obtaining image data associated with second spatial data and second temporal data related to one or more hazard-based event. The image data is classified into the hazard events using Convolutional Neural Network model. The Convolutional Neural Network model classifying the image data into a day image and a night image. Further, the day image comprises at least of a: clear day and rain, clear day and fog, clear day and snow day. The night image comprises at least of a: clear night and rain, clear night, and fog, clear nights, and snow. For example, the system 101 uses the convolutional neural network model 207 to classify the traffic image data and extracting spatial data and temporal data related to one or more hazard-based event. The image data associated with the one or more hazard-based event comprise a second hazard polygon.

At step 805, the method 800 comprises combining the first spatial data with the second spatial data based on a match between the first spatial data and the second spatial data and between the first temporal data and the second temporal data respectively. The combining comprises generating a union of the first hazard polygon and the second hazard polygon. The combining further comprises generating union of first hazard polygon and the second hazard polygon in real time.

At step 807, the method 800 comprises updating the map data based on the combining.

The method 800 may be implemented using corresponding circuitry. For example, the method 800 may be implemented by an apparatus or system comprising a processor, a memory, and a communication interface of the kind discussed in conjunction with FIG. 2A.

In some example embodiments, a computer programmable product may be provided. The computer programmable product may comprise at least one non-transitory computer-readable storage medium having stored thereon computer-executable program code instructions that when executed by a computer, cause the computer to execute the method 600.

In an example embodiment, an apparatus for performing the method 800 of FIG. 8 above may comprise a processor (e.g. the processor 201) configured to perform some or each of the operations of the method of FIG. 8 described previously. The processor may, for example, be configured to perform the operations (801-807) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (801-807) may comprise, for example, the processor 201 which may be implemented in the system 101 and/or a device or circuit for executing instructions or executing an algorithm for processing information as described above.

In this way, example embodiments of the invention results in generating a warning to the user of the hazard-based event in an area on a route. The invention may also provide alternate route(s) to the user via navigation system avoiding the area experiencing weather-based hazard. The invention also allows more accurate and wide area detection of weather-based hazard.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A method for updating map data comprising:
obtaining vehicle sensor data associated with first spatial data and first temporal data related to one or more hazard based event;
obtaining image data associated with second spatial data and second temporal data related to one or more hazard based event;
combining the first spatial data with the second spatial data based on a match between the first spatial data and the second spatial data and between the first temporal data and the second temporal data respectively; and
updating the map data based on the combining.

2. The method of claim 1, wherein the vehicle sensor data associated with the first spatial data and the first temporal data related to one or more hazard based event comprises a first hazard polygon.

3. The method of claim 2, wherein the image data associated with the second spatial data and second temporal data related the one or more hazard based event comprises a second hazard polygon.

4. The method of claim 3, wherein the combining comprises generating a union of the first hazard polygon and the second hazard polygon.

5. The method of claim 4, wherein the combining further comprises generating union of first hazard polygon and the second hazard polygon in real time.

6. The method of claim 1, wherein the one or more hazard events comprise at least one of a: rain, fog, slippery road, accident or broken down vehicle.

7. The method of claim 1, wherein the image data is classified into the hazard events using a Convolutional Neural Network model.

8. The method of claim 7, wherein the Convolutional Neural Network model is configured for classifying the image data into at least one of a day image and a night image.

9. The method of claim 8, wherein the day image comprises at least one of a: clear day and rain, clear day and fog, clear day and snow day.

10. The method of claim 8, wherein the night image comprises at least one of a: clear night and rain, clear night and fog, clear nights, and snow.

11. A system for updating map data comprising, the system comprising:
at least one non-transitory memory configured to store computer executable instructions; and
at least one processor configured to execute the computer executable instructions to:
obtain vehicle sensor data associated with first spatial data and first temporal data related to one or more hazard based event;
obtain image data associated with second spatial data and second temporal data related to one or more hazard based event;
combine the first spatial data with the second spatial data based on a match between the first spatial data and the second spatial data and between the first temporal data and the second temporal data respectively; and
update the map data based on the combining.

12. The system of claim 11, wherein the vehicle sensor data associated with the first spatial data and the first temporal data related to one or more hazard based event comprise a first hazard polygon.

13. The system of claim 12, wherein the image data associated with the second spatial data and second temporal data related one or more hazard based event comprise a second hazard polygon.

14. The system of claim 13, wherein the combining comprises generating a union of the first hazard polygon and the second hazard polygon.

15. The system of claim 14, wherein the combining further comprises generating union of first hazard polygon and the second hazard polygon in real time.

16. The system of claim 11, wherein the one or more hazard events comprise at least of a:
rain, fog, slippery road, accident or broken down vehicle.

17. The system of claim 11, wherein the image data is classified into the hazard events using a Convolutional Neural Network model.

18. The system of claim 17, wherein the Convolutional Neural Network model is configured for classifying the image data into at least one of a day image and a night image.

19. The system of claim 18, wherein the day image comprises at least one of a: clear day and rain, clear day and fog, clear day and snow day, and wherein the night image comprises at least one of a: clear night and rain, clear night and fog, clear nights, and snow.

20. A computer programmable product comprising a non-transitory computer readable medium having stored thereon computer executable instruction which when executed by one or more processors, cause the one or more processors to carry out operations for updating map data the operations comprising:
obtaining vehicle sensor data associated with first spatial data and first temporal data related to one or more hazard based event;
obtaining image data associated with second spatial data and second temporal data related to one or more hazard based event;
combining the first spatial data with the second spatial data based on a match between the first spatial data and the second spatial data and between the first temporal data and the second temporal data respectively; and
updating the map data based on the combining.
